(19) United States
(12) Patent Application Publication
(10) Pub. No.: US 2025/0016485 A1
(43) Pub. Date: Jan. 9, 2025

(54) MICROPHONE STAND STRUCTURE

(71) Applicant: Tymphany HK Limited, Hong Kong (HK)

(72) Inventors: Yu-Chao LIN, Taipei City (TW); Chia-Sheng WANG, Taipei City (TW); Ming-Chun LIN, Taipei City (TW)

(21) Appl. No.: 18/764,866

(22) Filed: Jul. 5, 2024

Related U.S. Application Data
(60) Provisional application No. 63/525,272, filed on Jul. 6, 2023.

(51) Int. Cl. H04R 1/08; F16M 11/04; F16M 11/10

(52) U.S. Cl. CPC H04R 1/08; F16M 11/04; F16M 11/10; F16M 2200/022

(57) ABSTRACT

A microphone stand structure includes a stand base, a frame set and a locking unit. The stand base includes a supporting rod, one end of the supporting rod includes a tapered groove and a first hole, the first hole penetrates the bottom of the tapered groove, and the inner wall of the tapered groove includes a first tooth part. A second hole penetrates a tapered convex part, a surface of the tapered convex part includes a second tooth part, the tapered convex part is fitted into the tapered groove, the second tooth part meshes with the first tooth part, and the second hole links to the first hole. The locking unit penetrates the first hole of the supporting rod and the second hole of the fastener.

### BACKGROUND OF THE INVENTION

The present invention relates to the technical field of the microphone structure; more particularly, it relates to a microphone stand structure for supporting the microphone.

### DESCRIPTION OF THE PRIOR ART

The fixing methods of existing microphone supporting frames are diverse, but most of them use a supporting rod as the main supporting structure. At one end of the supporting rod, a clamping and fixing structure is designed, which can be used to clamp and fix the microphone. However, the body of the existing microphone is too heavy, which easily causes the clamping and fixing structure to fail to hold the weight of the microphone, leading to the microphone falling. Alternatively, the body of the microphone is so heavy that the entire microphone supporting frame cannot support it, making it difficult for users to use the microphone supporting frame. Additionally, sometimes the clamping force of the microphone supporting frame is too strong in order to securely hold the microphone, resulting in damage to the microphone.

### SUMMARY OF THE INVENTION

A microphone stand structure is provided in the embodiment of the present invention, which solves the problem of insufficient structural support force of the microphone supporting frame of the prior art via the design of the supporting rod and the fastener through the teeth.

To solve the abovementioned problem, the present invention is implemented as follows.

A microphone stand structure includes a stand base, a frame set and a locking unit. The stand base includes a supporting rod, one end of the supporting rod includes a tapered groove and a first hole, wherein the first hole penetrates a bottom of the tapered groove, an inner wall of the tapered groove includes a first tooth part; the frame set includes a supporting frame and a fastener, the supporting frame is used for supporting the microphone, one side of the fastener is located on the supporting frame, the other side of the fastener includes a tapered convex part and a second hole, the second hole penetrates the tapered convex part, a surface of the tapered convex part includes a second tooth part, the tapered convex part is fitted into the tapered groove, the second tooth part meshes with the first tooth part, the second hole links to the first hole; and one end of which passes through the first hole of the supporting rod and the second hole of the fastener.

In one of the embodiments, a hole of the second hole includes an internal thread, one end of the locking unit includes an external thread, and the end of the locking unit is fastened to the internal thread of the second hole.

In one of the embodiments, the second tooth part of the tapered convex part is formed via 36 teeth with each tooth spaced 10 degrees apart, 24 teeth with each tooth spaced 15 degrees apart, or 18 teeth with each tooth spaced 20 degrees apart.

In one of the embodiments, the microphone stand structure further includes a gasket located between the locking unit and the supporting rod, wherein the locking unit passes through the gasket and is located on one side of the supporting rod away from the fastener.

In one of the embodiments, the other end of the locking unit includes a locking head, and the locking head includes a concave contour.

In one of the embodiments, the supporting frame includes an inner frame and an outer fixing frame, the inner frame includes a fixing part and a frame part, the fixing part is located on the frame part, the frame part is located in the outer fixing frame, and one side of the fastener is located on the fixing part.

In one of the embodiments, the outer fixing frame is shaped as a U-shaped structure, the outer fixing frame includes an outer frame part and an inner frame part, the outer frame part covers an outside of the inner frame part, the frame part of the inner frame is located between the outer frame part and the inner frame part, the fixing part of the inner frame passes through the outer frame part, and the fixing part protrudes from one side of the outer fixing frame.

In one of the embodiments, the frame part of the inner frame fits the U-shaped structure of the outer fixing frame.

In one of the embodiments, the frame part of the inner frame includes a plurality of first fixing points, the inner frame part of the outer fixing frame includes a plurality of second fixing points corresponded to the plurality of the first fixing points, the plurality of the first fixing points are fastened to the plurality of the second fixing points.

In one of the embodiments, the microphone stand structure further includes a plurality of connectors, one end of each of the plurality of the connectors is located on an inside of the inner frame part of the outer fixing frame, the other end of each of the plurality of the connectors is connected to the microphone.

In one of the embodiments, the connector is an elastic unit or a fixing rope.

In one of the embodiments, the stand base further includes a base plate, and the supporting rod is located vertically on the base plate.

In one of the embodiments, the fixing part and the frame part are formed integrally.

A microphone stand structure is provided in the present invention, wherein the supporting rod of the stand base has a tapered groove, the inner wall of the tapered groove has a first tooth part, and a first hole penetrates the bottom of the tapered groove, the fastener of the support element has a tapered convex part with a second tooth part on its surface, and a second hole penetrates the tapered convex part. The tapered convex part of the fastener is fitted into the tapered groove of the supporting rod, the second tooth part meshes with the first tooth part, and the second hole links to the first hole. A locking unit is then put to pass through the first hole and the second hole for fixing. This combination of the first tooth part and the second tooth part enhances the bonding strength, and the use of a tapered helical tooth design increases the load-bearing capacity.

### BRIEF DESCRIPTION OF DRAWINGS

The accompanying drawings described here are provided to offer a further understanding of the present invention and constitute a part of the present invention. The illustrative embodiments of the present invention and their descriptions are used to explain the present invention and do not constitute undue limitations on the present invention. In the drawings:

FIG. 1 is a perspective view of the microphone stand structure of the present invention;

FIG. 2 is a sectional view along line A-A′ of FIG. 1;

FIG. 3 is an exploded view of the microphone stand structure of the present invention;

FIG. 4 is another exploded view of the microphone stand structure of the present invention; and

FIG. 5 is a schematic drawing of the supporting element of the microphone stand structure of the present invention.

The detailed description in conjunction with the accompanying drawings is as follows: 1: microphone stand structure; 11: stand base; 111: supporting rod; 112: tapered groove; 113: first hole; 114: base plate; 1121: first tooth part; 113: base plate; 12: frame set; 121: supporting frame; 1211: inner frame; 1212: outer fixing frame; 1213: fixing part; 1214: frame part; 12141: first fixing point; 1215: outer frame part; 1216: inner frame part; 12161: second fixing point; 122: fastener; 123: tapered convex part; 1231: second tooth part; 1232: convex head; 124: second hole; 1241: internal thread; 13: locking unit; 131: external thread; 132: locking head; 1321: concave contour; 14: gasket; 15: connector; 2: microphone.

### DETAILED DESCRIPTION

The present invention will be disclosed in multiple embodiments with reference to the drawings. For clarity, numerous implementation details will be explained in the following descriptions. However, it should be understood that these implementation details should not be used to limit the present invention. In other words, in some embodiments of the present invention, these implementation details are not necessary. Moreover, for the sake of simplicity in the drawings, some conventional structures and components will be depicted in a simplified schematic manner. In the following embodiments, the same reference numbers will denote the same or similar components.

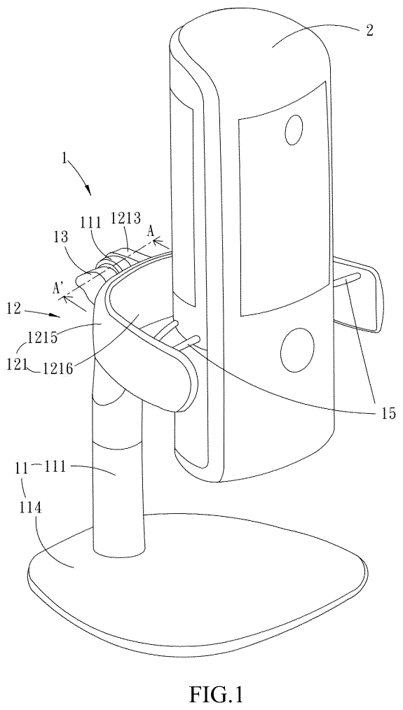

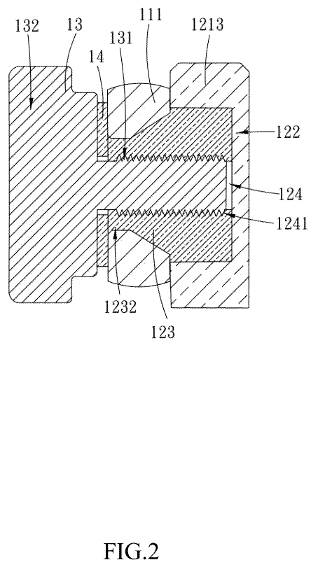

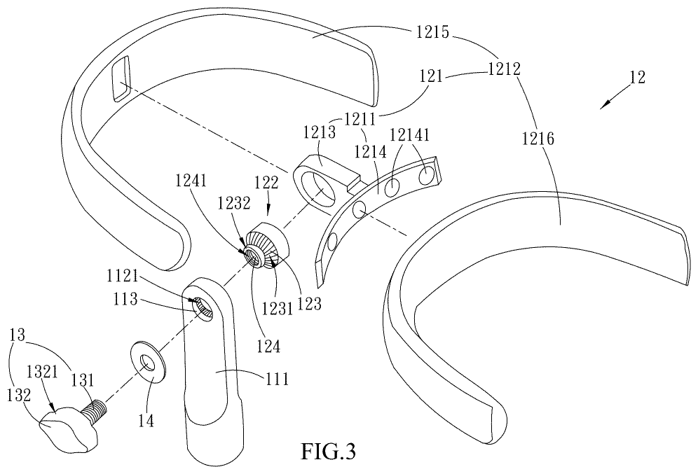

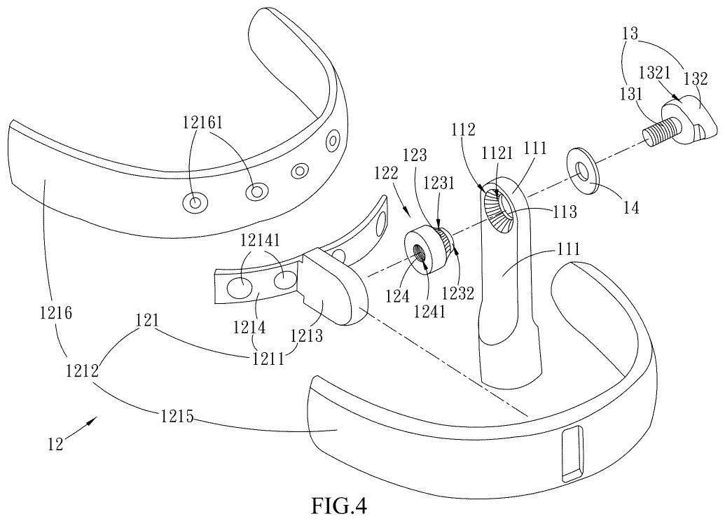

FIG. 1 is a perspective view of the microphone stand structure of the present invention, FIG. 2 is a cross-sectional view along line A-A′ of FIG. 1, FIG. 3 is an exploded view of the microphone stand structure, and FIG. 4 is another exploded view of the microphone stand structure. As shown in FIG. 1 to FIG. 4, a microphone stand structure 1 is provided in the present invention, which includes a stand base 11, a frame set 12, and a locking unit 13. The stand base 11 includes a supporting rod 111, one end of the supporting rod 111 includes a tapered groove 112 and a first hole 113, and the first hole 113 penetrates the bottom of the tapered groove 112. The inner wall of the tapered groove 112 includes a first tooth part 1121. The frame set 12 includes a supporting frame 121 and a fastener 122. The supporting frame 121 is used for supporting a microphone 2, and one side of the fastener 122 is located on the supporting frame 121. The other side of the fastener 122 includes a tapered convex part 123 and a second hole 124. The second hole 124 penetrates the tapered convex part 123, and the surface of the tapered convex part 123 includes a second tooth part 1231. The tapered convex part 123 is fitted into the tapered groove 112, the second tooth part 1231 meshes with the first tooth part 1121, and the second hole 124 links to the first hole 113. One end of the locking unit 13 penetrates the first hole 113 of the supporting rod 111 and the second hole 124 of the fastener 122.

In this embodiment, the stand base 11 further includes a base plate 114, and the supporting rod 111 is vertically located on the base plate 114. The shape of the tapered groove 112 of the supporting rod 111 is that the opening of the groove is larger than the bottom of the groove. The groove shape of the tapered groove 112 corresponds to the convex shape of the tapered convex part 123 of the fastener 122, and the fastener 122 is fitted into the tapered groove 112, allowing the fastener 122 to fit completely within the tapered groove 112. The first tooth part 1121 within the tapered groove 112 is corresponded to the second tooth part 1231 of the tapered convex part 123. In this embodiment, the teeth of the second tooth part 1231 of the tapered convex part 123 can be arranged in various methods, for example: a set of 36 teeth with each tooth spaced 10 degrees apart, a set of 24 teeth with each tooth spaced 15 degrees apart, or a set of 18 teeth with each tooth spaced 20 degrees apart. These methods can be selected based on user requirements. The combination of the first tooth part 1121 and the second tooth part 1231 enhances the bonding strength of the frame set 12. Additionally, the combination of the tapered groove 112 of the supporting rod 111 and the tapered convex part 123 of the fastener 122 utilizes a tapered helical tooth design to enhance the load-bearing capacity of the frame set 12.

Referring to FIG. 2, the tapered convex part 123 of the fastener 122 further includes a convex head 1232. The convex head 1232 of the tapered convex part 123 is fitted precisely into the first hole 113 of the tapered groove 112 of the supporting rod 111. In this way, in addition to mesh with the second tooth part of the tapered groove 112 via the first tooth part 1121, the tapered convex part 123 furthermore embeds into the first hole 113 of the tapered groove 112 via the convex head 1232. This ensures a tight fit between the tapered convex part 123 and the tapered groove 112. Additionally, the second hole 124 is passed through by the convex head 1232 of the tapered convex part 123, and the interior of the second hole 124 includes internal threads 1241. One end of the locking unit 13 includes external threads 131. One end of the locking unit 13 is fastened to the internal threads 1241 of the second hole 124. Thus, the locking unit 13 can fix the supporting rod 111 and the fastener 122 together.

Furthermore, between the locking unit 13 and the supporting rod 111, there is a gasket 14. The locking unit 13 passes through the gasket 14 and is located on the side of the supporting rod 111 away from the fastener 122. The gasket 14 facilitates the locking unit 13 in fastening the supporting rod 111 and the fastener 122 together. Additionally, the other end of the locking unit 13 includes a locking head 132, and the locking head 132 has a concave contour 1321. The concave contour 1321 is designed for allowing the user to rotate the locking head 132 easily.

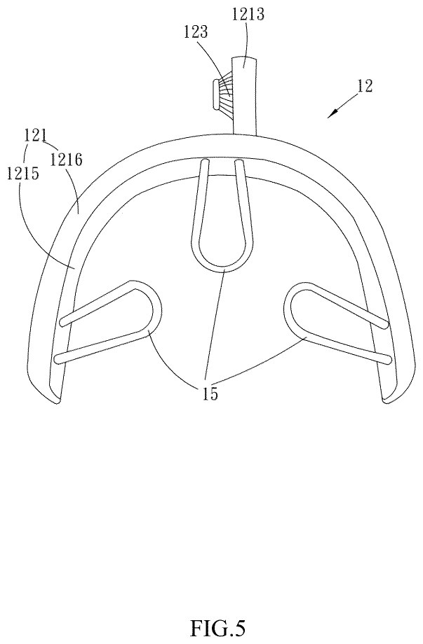

FIG. 5 is a schematic drawing of the supporting frame element of the microphone stand structure of the present invention. As shown in figures, in this embodiment, the supporting frame 121 includes an inner frame 1211 and an outer fixing frame 1212, the inner frame 1211 includes a fixing part 1213 and a frame part 1214, the fixing part 1213 is located on the frame part 1214, and the frame part 1214 is located inside the outer fixing frame 1212. One side of the fastener 122 is located on the fixing part 1213, while the tapered convex part 123 protrudes from the other side of the fastener 122. The fixing part 1213 and the frame part 1214 are formed integrally. Moreover, the outer fixing frame 1212 is shaped as a U-shaped structure, and the center of the outer fixing frame 1212 is used for fixing the microphone 2. The outer fixing frame 1212 includes an outer frame part 1215 and an inner frame part 1216. The outer frame part 1215 covers the outside of the inner frame part 1216. The frame part 1214 of the inner frame 1211 is located between the outer frame part 1215 and the inner frame part 1216. The fixing part 1213 of the inner frame 1211 passes through the outer frame part 1215, and the fixing part 1213 protrudes from one side of the outer fixing frame 1212.

Referring to FIG. 1 and FIG. 5, the frame part 1214 of the inner frame 1211 snugly fits the U-shaped structure of the outer fixing frame 1212, the frame part 1214 of the inner frame 1211 includes a plurality of multiple first fixing points 12141, while the inner frame part 1216 of the outer fixing frame 1212 includes a plurality of second fixing points 12161 corresponded to the plurality of first fixing points 12141, and the plurality of first fixing points 12141 are fastened to the plurality of second fixing points 12161. Referring to FIG. 5 again, the microphone stand structure 1 further includes a plurality of connectors 15, with one end of each of the plurality of connectors 15 is located on the inside the inner frame part 1216 of the outer fixing frame 1212, and the other end of each of the plurality of connectors 15 is connected to the microphone 2. Each connector 15 can be an elastic unit or a fixing rope.

In summary, a microphone stand structure is provided in the present invention, that fixes the fixing part to one side of the supporting rod of the stand base, wherein the supporting rod includes a tapered groove, the inner wall of the tapered groove includes a first tooth part, a first hole penetrates the bottom of the tapered groove, the fastener of the supporting frame includes a tapered convex part with a surface which includes a second tooth part, and a second hole penetrates the tapered convex part. The tapered convex part of the fastener is fitted into the tapered groove of the supporting rod, the second tooth part meshes with the first tooth part, and the second hole links to the first hole. Furthermore, a locking unit is inserted to pass through the first hole and the second hole to fix them together, thus, this combination of the first tooth part and the second tooth part enhances the bonding strength, utilizing a tapered helical tooth design to enhance load-bearing capacity.

It should also be noted that the terms “including,” “comprising,” or any other variations thereof are intended to cover non-exclusive inclusion. Thus, a process, method, article, or apparatus that includes a list of elements not only includes those elements but may also include other elements not explicitly listed, or elements inherent to such a process, method, article, or apparatus. Without further limitation, an element defined by the phrase “including a . . . ” does not exclude the existence of additional identical elements in the process, method, article, or apparatus that includes the element.

The above description shows and describes several preferred embodiments of the present invention. However, as previously noted, it should be understood that the present invention is not limited to the forms disclosed herein and should not be regarded as excluding other embodiments. It may be used in various other combinations, modifications, and environments, and can be adapted within the scope of the utility model concepts as taught herein or through the application of known techniques or knowledge in the relevant field. Modifications and variations made by those skilled in the art without departing from the spirit and scope of the present invention are to be included within the protection scope of the appended claims.

1. A microphone stand structure, comprising:
a stand base, comprising a supporting rod, one end of the supporting rod comprising a tapered groove and a first hole, wherein the first hole penetrates a bottom of the tapered groove; and an inner wall of the tapered groove comprises a first tooth part;
a frame set, comprising:
a supporting frame configured to support a microphone; and
a fastener, one side of the fastener being located on the supporting frame; and another other side of the fastener comprising:
a tapered convex part, and
a second hole penetrating the tapered convex part, a surface of the tapered convex part comprising a second tooth part, the tapered convex part being fitted into the tapered groove, and the second tooth part meshing with the first tooth part, wherein the second hole links to the first hole; and
a locking having one end passing through the first hole of the supporting rod and the second hole of the fastener.

2. The microphone stand structure as claimed in claim 1, wherein; a hole of the second hole comprises an internal thread,
wherein one end of the locking unit comprises an external thread, and
wherein the end of the locking unit is fastened to the internal thread of the second hole.

3. The microphone stand structure as claimed in claim 1, wherein the second tooth part of the tapered convex part is formed via 36 teeth with each tooth spaced 10 degrees apart, 24 teeth with each tooth spaced 15 degrees apart, or 18 teeth with each tooth spaced 20 degrees apart.

4. The microphone stand structure as claimed in claim 1, further comprising a gasket located between the locking unit and the supporting rod,
wherein the locking unit passes through the gasket and is located on one side of the supporting rod away from the fastener.

5. The microphone stand structure as claimed in claim 1, wherein another end of the locking unit comprises a locking head, and the locking head comprises a concave contour.

6. The microphone stand structure as claimed in claim 1, wherein the supporting frame comprises:
an inner frame, comprising:
a frame part; and
a fixing part located on the frame part; and
an outer fixing frame,
wherein the frame part is located in the outer fixing frame, and
wherein one side of the fastener is located on the fixing part.

7. The microphone stand structure as claimed in claim 6, wherein the outer fixing frame is shaped as a U-shaped structure,
wherein the outer fixing frame comprises:
an inner frame part; and
an outer frame part covering an outside of the inner frame part,
wherein the frame part of the inner frame is located between the outer frame part and the inner frame part,
wherein the fixing part of the inner frame passes through the outer frame part, and
wherein the fixing part protrudes from one side of the outer fixing frame.

8. The microphone stand structure as claimed in claim 7, wherein the frame part of the inner frame fits the U-shaped structure of the outer fixing frame.

9. The microphone stand structure as claimed in claim 7, wherein the frame part of the inner frame comprises a plurality of first fixing points, and
wherein the inner frame part of the outer fixing frame comprises a plurality of second fixing points corresponding to the plurality of the first fixing points, the plurality of the first fixing points being fastened to the plurality of the second fixing points.

10. The microphone stand structure as claimed in claim 7, further comprising a plurality of connectors, one end of each of the plurality of the connectors being located on an inside of the inner frame part of the outer fixing frame; and another other end of each of the plurality of the connectors being connected to the microphone.

11. The microphone stand structure as claimed in claim 10, wherein the connector is an elastic unit or a fixing rope.

12. The microphone stand structure as claimed in claim 1, wherein the stand base further comprises a base plate, and the supporting rod is located vertically on the base plate.

13. The microphone stand structure as claimed in claim 1, wherein the fixing part and the frame part are formed integrally.
